(19) United States
(12) Patent Application Publication
(10) Pub. No.: US 2014/0070726 A1
(43) Pub. Date: Mar. 13, 2014

(54) LED DRIVING APPARATUS AND OPERATING METHOD THEREOF

(71) Applicant: Raydium Semiconductor Corporation, Hsinchu (TW)

(72) Inventors: Chung-Tai Cheng, Zhubei City (TW); Chia-Hsiu Lin, Hsinchu City (TW)

(73) Assignee: Raydium Semiconductor Corporation, Hsinchu (TW)

(21) Appl. No.: 14/020,199

(22) Filed: Sep. 6, 2013

(30) Foreign Application Priority Data
Sep. 13, 2012 (TW) 101133512

(51) Int. Cl. H05B 33/08

(52) U.S. Cl. CPC H05B 33/0821
USPC 315/297

(57) ABSTRACT

A LED driving apparatus includes an output stage, an input resistor, a plurality of voltage dividing resistors, and a control circuit. The output stage includes at least one LED. A first voltage dividing resistor, a second voltage dividing resistor, and a third voltage dividing resistor are coupled between a specific voltage and ground in series to divide the specific voltage. A LED current passing through the LED has a duty cycle changed with the specific voltage. The control circuit senses a first voltage signal, a second voltage signal, and a third voltage signal between the first voltage dividing resistor and the second voltage dividing resistor, between the second voltage dividing resistor and the third voltage dividing resistor, and the input resistor respectively, and adjusts a setting voltage signal according to the first voltage signal, the second voltage signal, and the third voltage signal.

### BACKGROUND OF THE INVENTION

1. Field of the Invention

The invention relates to the driving of a light-emitting diode (LED); in particular, to a LED driving apparatus and operating method thereof.

2. Description of the Prior Art

In general, the operation theorem of the conventional AC to DC type of LED driving circuit is to use an AC to DC converter to generate the input voltage needed to conduct upper side of the LED to drive the LED to emit lights, and simultaneously disposes a current source circuit at lower side of the LED to control the fixed current flowing through the LED to the ground terminal, and the brightness of the LED can be stabilized. Since the input voltage is a rectified signal instead of DC voltage, the LED driving circuit is necessary to drive the LED to achieve better power factor (PF) and luminous efficiency.

However, the setting voltage outputted from the setting voltage generator to the current source circuit at lower side of the LED is changed with the input voltage in the prior art; therefore, as shown in the wave-form diagrams of its input voltage, LED current, and power consumption of FIG. 1A˜FIG. 1C, the LED current (I_{LED}) is changed with different input voltages. When the input voltage becomes larger, the LED current (I_{LED}) also becomes larger; therefore, it will cause the problem of inaccurate LED current at different input voltages (high input voltage VH and low input voltage VL), namely the problem of poor input voltage line regulation. In addition, because both the voltage and current of the current source circuit disposed at the lower side of the LED become larger, the power consumption will also become larger to cause the overheat problem.

Therefore, the invention provides a LED driving apparatus and operating method thereof to solve the above-mentioned problems occurred in the prior arts.

### SUMMARY OF THE INVENTION

An embodiment of the invention is a LED driving apparatus. In this embodiment, the LED driving apparatus includes an output stage, an input resistor, a plurality of voltage dividing resistors, and a control circuit. The output stage includes at least one LED. One end of the input resistor is coupled to an input voltage. The plurality of voltage dividing resistors is coupled between a specific voltage and a ground terminal. The plurality of voltage dividing resistors at least includes a first voltage dividing resistor, a second voltage dividing resistor, and a third voltage dividing resistor coupled in series to divide the specific voltage. A LED current passing through the LED has a duty cycle changed with the specific voltage.

The control circuit is coupled to the output stage, another end of the input resistor, between the first voltage dividing resistor and the second voltage dividing resistor, and between the second voltage dividing resistor and the third voltage dividing resistor respectively. The control circuit senses a first voltage signal, a second voltage signal, and a third voltage signal between the first voltage dividing resistor and the second voltage dividing resistor, between the second voltage dividing resistor and the third voltage dividing resistor, and the another end of the input resistor respectively, and adjusts a setting voltage signal outputted from the control circuit to the output stage according to the first voltage signal, the second voltage signal, and the third voltage signal.

Another embodiment of the invention is a LED driving apparatus operating method. In this embodiment, the LED driving apparatus operating method is used to operate a LED driving apparatus including an output stage, an input resistor, a plurality of voltage dividing resistors, and a control circuit. The plurality of voltage dividing resistors is coupled between a specific voltage and a ground terminal. The plurality of voltage dividing resistors at least includes a first voltage dividing resistor, a second voltage dividing resistor, and a third voltage dividing resistor coupled in series. A LED current passing through the LED has a duty cycle changed with the specific voltage. The control circuit is coupled to the output stage, another end of the input resistor, between the first voltage dividing resistor and the second voltage dividing resistor, and between the second voltage dividing resistor and the third voltage dividing resistor respectively. The output stage includes at least one LED.

The LED driving apparatus operating method includes steps of: (a) using the first voltage dividing resistor, the second voltage dividing resistor, and the third voltage dividing resistor to divide the input voltage; (b) sensing a first voltage signal, a second voltage signal, and a third voltage signal between the first voltage dividing resistor and the second voltage dividing resistor, between the second voltage dividing resistor and the third voltage dividing resistor, and the another end of the input resistor respectively; (c) adjusting a setting voltage signal outputted from the control circuit to the output stage according to the first voltage signal, the second voltage signal, and the third voltage signal.

Compared to the prior art, the LED driving apparatus and operating method thereof can achieve the effects of: (1) effectively avoiding the excessive power consumption problem and overheat problem when the input voltage is excessive; (2) effectively avoiding the problem of inaccurate LED current at different input voltages, namely the problem of poor input voltage line regulation; (3) making the LED to work at the best current corresponding brightness point.

The advantage and spirit of the invention may be understood by the following detailed descriptions together with the appended drawings.

### BRIEF DESCRIPTION OF THE APPENDED DRAWINGS

FIG. 1A˜FIG. 1C illustrate wave-form diagrams of input voltage, LED current, and power consumption of the LED driving apparatus in prior art respectively.

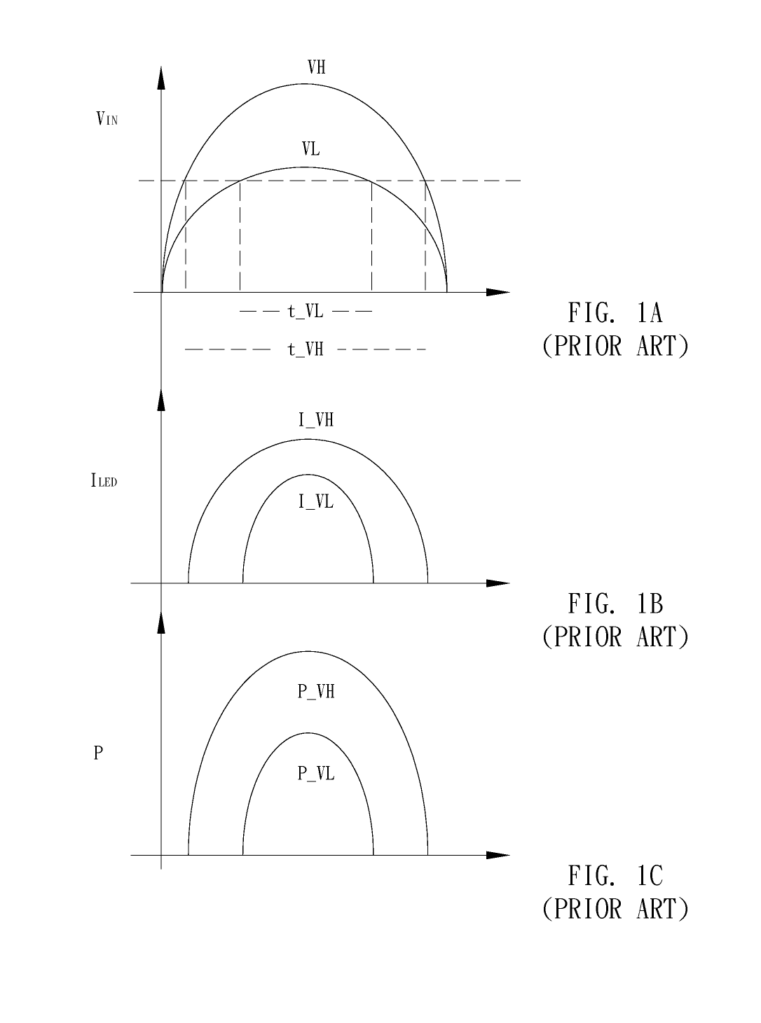

FIG. 2 illustrates a schematic diagram of the circuit structure of the LED driving apparatus in an embodiment of the invention.

FIG. 3 illustrates a schematic diagram of the circuit structure of the control circuit in FIG. 2.

FIG. 4A˜FIG. 4C illustrate wave-form diagrams of input voltage, LED current, and power consumption of the LED driving apparatus in FIG. 2 respectively.

FIG. 5 illustrates a schematic diagram of the circuit structure of the LED driving apparatus in another embodiment of the invention.

FIG. 6 illustrates a schematic diagram of the circuit structure of the control circuit in FIG. 5.

FIG. 7A˜FIG. 7C illustrate wave-form diagrams of input voltage, LED current, and power consumption of the LED driving apparatus in FIG. 5 respectively.

FIG. 8 illustrates a flow chart of the LED driving apparatus operating method in another embodiment of the invention.

### DETAILED DESCRIPTION OF THE INVENTION

An embodiment of the invention is a LED driving apparatus. In this embodiment, the LED driving apparatus is used to drive the LED to emit lights, but not limited to this.

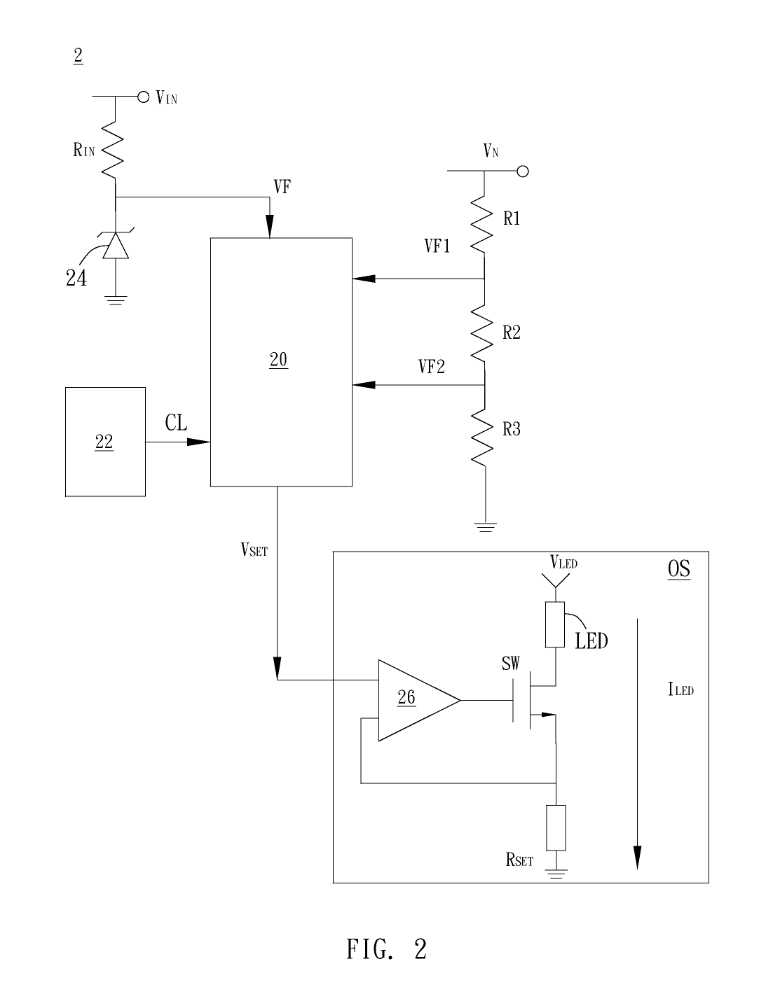

Please refer to FIG. 2. FIG. 2 illustrates a schematic diagram of the circuit structure of the LED driving apparatus in this embodiment. As shown in FIG. 2, the LED driving apparatus 2 includes an output stage OS, an input resistor R_{IN}, a control circuit 20, a clock generator 22, a regulator 24, a first voltage dividing resistor R₁, a second voltage dividing resistor R₂, and a third voltage dividing resistor R₃ coupled in series.

One end of the input resistor R_{IN} is coupled to an input voltage V_{IN} and another end of the input resistor R_{IN} is coupled to the regulator 24. The control circuit 20 is coupled to the output stage OS, the clock generator 22, between the input resistor R_{IN} and the regulator 24, between the first voltage dividing resistor R₁ and the second voltage dividing resistor R₂, and between the second voltage dividing resistor R₂ and the third voltage dividing resistor R₃ respectively.

The output stage OS includes a comparator 26, a light-emitting diode LED, a switch SW, and a setting resistor R_{SET}. Two input terminals of the comparator 26 are coupled to the control circuit 20 and between the switch SW and the setting resistor R_{SET}; an output terminal of the comparator 26 is coupled to the switch SW. The light-emitting diode LED is coupled between a LED voltage V_{LED} and the switch SW.

The first voltage dividing resistor R₁, the second voltage dividing resistor R₂, and the third voltage dividing resistor R₃ are coupled in series between a specific voltage V_{N} and a ground terminal and used to divide the specific voltage V_{N}. Wherein, a LED current I_{LED} passing through the light-emitting diode LED of the output stage OS has a duty cycle related to the specific voltage V_{N}. In practical applications, when the specific voltage V_{N} becomes larger, the duty cycle of the LED current I_{LED} will become smaller. The specific voltage V_{N} can be related to the input voltage V_{IN} or the LED voltage V_{LED}, but not limited to this.

The control circuit 20 senses a first voltage signal VF1, a second voltage signal VF2, and a third voltage signal VF between the first voltage dividing resistor R₁ and the second voltage dividing resistor R₂, between the second voltage dividing resistor R₂ and the third voltage dividing resistor R₃, and between the input resistor R_{IN} and the regulator 24 respectively, and the control circuit 20 outputs a setting voltage V_{SET} to the comparator 26 of the output stage OS. It should be noticed that the output stage OS can include no comparator and the setting voltage V_{SET} outputted from the control circuit 20 can be directly received by the gate electrode of the switch SW.

The control circuit 20 will determine the value of the input voltage V_{IN} according to the first voltage signal VF1, the second voltage signal VF2, and the third voltage signal VF. The clock generator 22 will generate a clock signal CL to the control circuit 20 for the control circuit 20 to adjust a duty cycle of the setting voltage V_{SET} outputted by the control circuit 20.

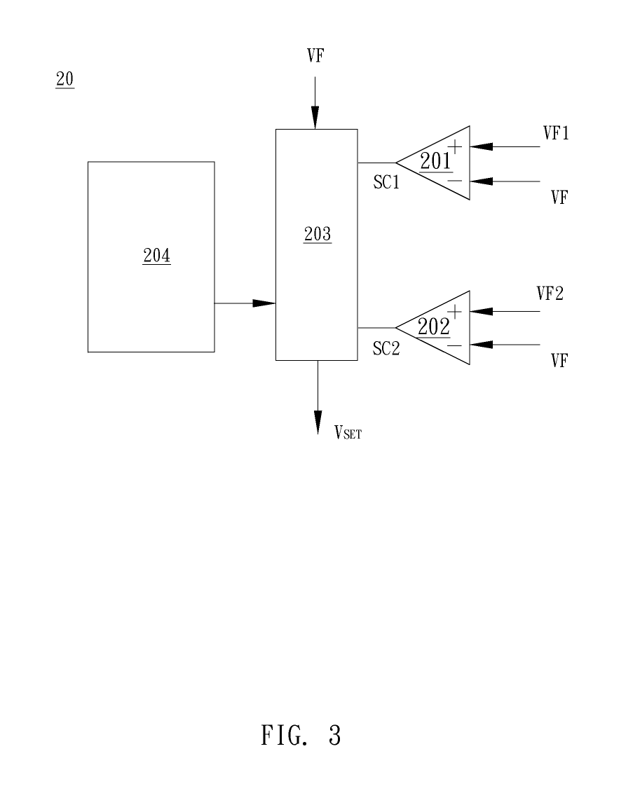

Please refer to FIG. 3. FIG. 3 illustrates a schematic diagram of the circuit structure of the control circuit 20 in FIG. 2. As shown in FIG. 3, the control circuit 20 includes a first comparator 201, a second comparator 202, a multiplexer 203, and a ramp generator 204. Wherein, the first comparator 201, the second comparator 202, and the ramp generator 204 are coupled to the multiplexer 203 respectively. The first comparator 201 compares the first voltage signal VF1 and the third voltage signal VF to generate a first compared result SC1. The second comparator 202 compares the second voltage signal VF2 and the third voltage signal VF to generate a second compared result SC2. Then, the multiplexer 203 determines a voltage value of the specific voltage V_{N} according to the first compared result SC1, the second compared result SC2, and the third voltage signal VF, and controls the ramp generator 204 to generate a corresponding ramp according to the voltage value of the specific voltage V_{N} to adjust a duty cycle of the setting voltage signal V_{SET} outputted from the multiplexer 203 to the output stage OS. By doing so, the output stage OS can also adjust a duty cycle of the LED current I_{LED} passing through the light-emitting diode LED accordingly.

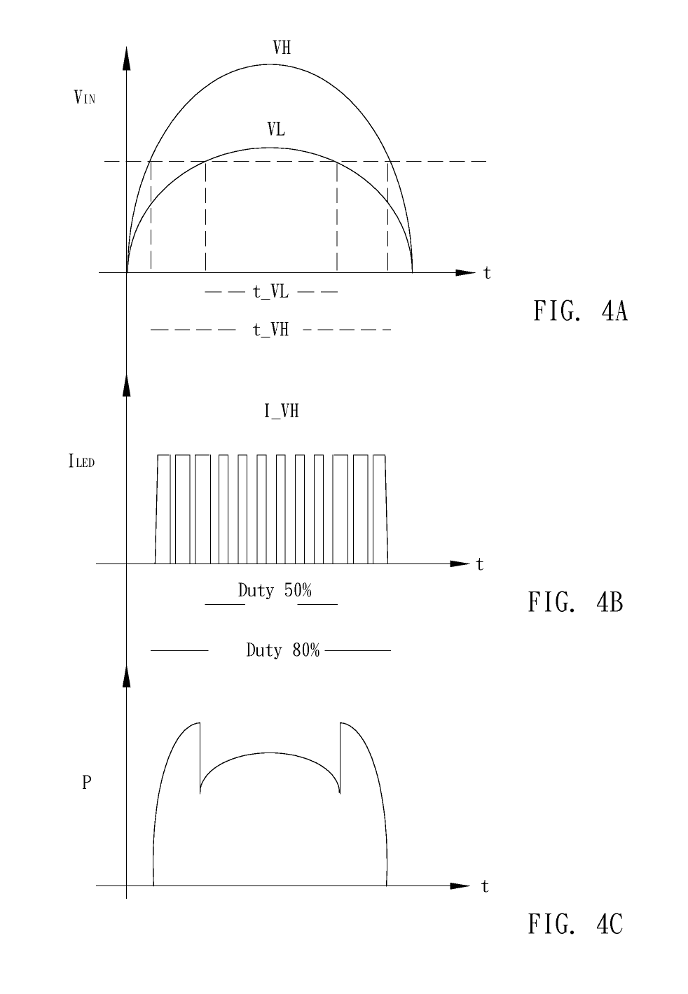

Please refer to FIG. 4A through FIG. 4C. FIG. 4A˜FIG. 4C illustrate wave-form diagrams of the input voltage V_{IN}, the LED current I_{LED}, and the power consumption P of the LED driving apparatus 2 respectively. As shown in FIG. 4B, when the input voltage V_{IN} becomes larger, the duty cycle of the LED current I_{LED} will become smaller, namely the width of the pulse will become narrower. Thus, as shown in FIG. 4C, when the input voltage V_{IN} becomes larger, since the duty cycle of the LED current I_{LED} becomes smaller, the power consumption P of the LED driving apparatus 2 will be decreased instead of being increased. Therefore, the excessive power consumption problem and overheat problem can be effectively avoided.

Another embodiment of the invention is a LED driving apparatus. In this embodiment, the LED driving apparatus is used to drive the LED to emit lights, but not limited to this.

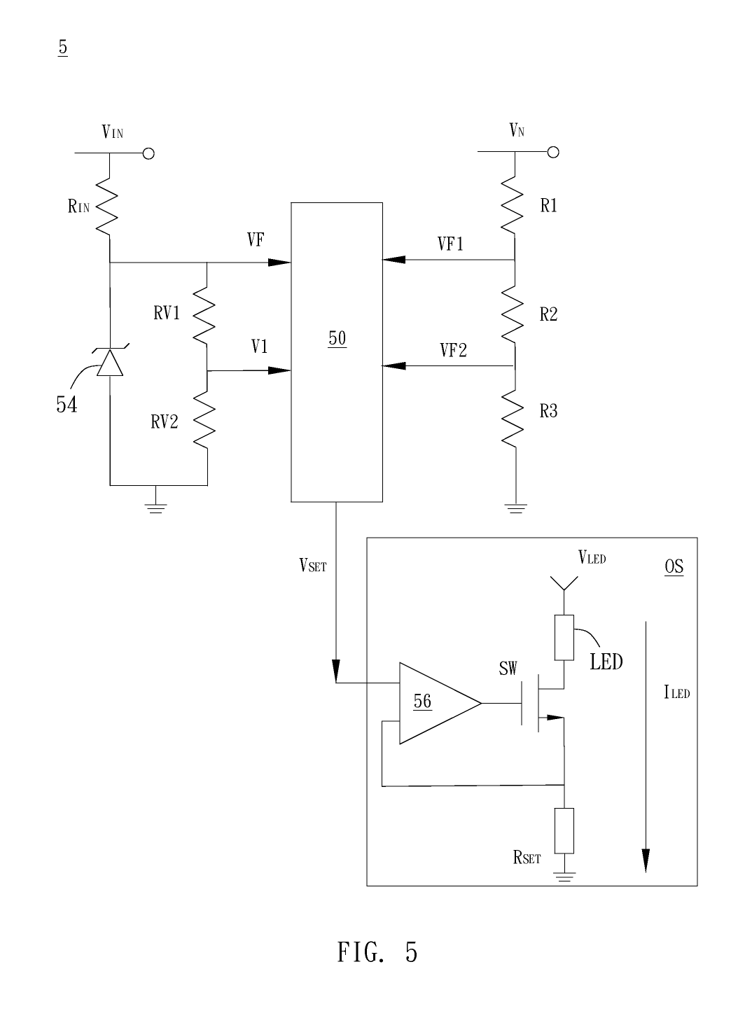

Please refer to FIG. 5. FIG. 5 illustrates a schematic diagram of the circuit structure of the LED driving apparatus in this embodiment. As shown in FIG. 5, the LED driving apparatus 5 includes an output stage OS, an input resistor R_{IN}, a control circuit 50, a first voltage dividing resistor R₁, a second voltage dividing resistor R₂, and a third voltage dividing resistor R₃ coupled in series, a regulator 54, and a fourth voltage dividing resistor RV₁ and a fifth voltage dividing resistor RV₂ coupled in series.

One end of the input resistor R_{IN} is coupled to the input resistor R_{IN}, another end of the input resistor R_{IN} is coupled to the regulator 54. The first voltage dividing resistor R₁, the second voltage dividing resistor R₂, and the third voltage dividing resistor R₃ are coupled between the specific voltage V_{N} and the ground terminal to divide the specific voltage V_{N}. The control circuit 50 is coupled to the output stage OS, between the input resistor R_{IN} and the regulator 54, between the first voltage dividing resistor R₁ and the second voltage dividing resistor R₂, between the second voltage dividing resistor R₂ and the third voltage dividing resistor R₃, between the fourth voltage dividing resistor RV₁ and the fifth voltage dividing resistor RV₂.

The output stage OS includes a comparator 56, a light-emitting diode LED, a switch SW, and a setting resistor R_{SET}. Two input terminals of the comparator 56 are coupled to the control circuit 50 and between the switch SW and the setting resistor R_{SET}; an output terminal of the comparator 56 is coupled to the switch SW. The light-emitting diode LED is coupled between a LED voltage V_{LED} and the switch SW.

The control circuit 50 senses a first voltage signal VF1, a second voltage signal VF2, a third voltage signal VF, and a fourth voltage signal V1 between the first voltage dividing resistor R₁ and the second voltage dividing resistor R₂, between the second voltage dividing resistor R₂ and the third voltage dividing resistor R₃, between the input resistor R_{IN} and the regulator 54, and between the fourth voltage dividing resistor RV₁ and the fifth voltage dividing resistor RV₂ respectively, and the control circuit 50 outputs a setting voltage V_{SET} to the comparator 56 of the output stage OS. It should be noticed that the output stage OS can include no comparator and the setting voltage V_{SET} outputted from the control circuit 50 can be directly received by the gate electrode of the switch SW.

The control circuit 50 will determine the value of the specific voltage V_{N} according to the first voltage signal VF1, the second voltage signal VF2, the third voltage signal VF, and the fourth voltage signal V1 and adjust a value of the setting voltage V_{SET} according to the value of the specific voltage V_{N}.

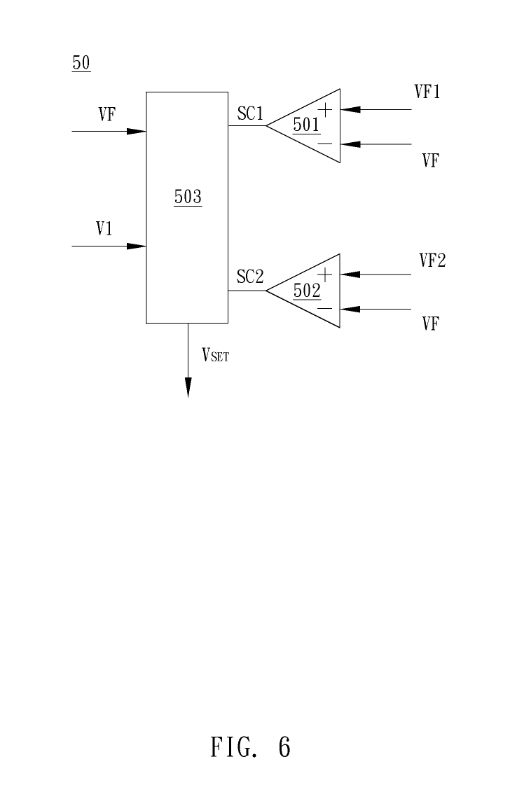

Please refer to FIG. 6. FIG. 6 illustrates a schematic diagram of the circuit structure of the control circuit 50 in FIG. 5. As shown in FIG. 6, the control circuit 50 includes a first comparator 501, a second comparator 502, and a multiplexer 503. Wherein, the first comparator 501 and the second comparator 502 are coupled to the multiplexer 503 respectively. The first comparator 501 compares the first voltage signal VF1 and the third voltage signal VF to generate a first compared result SC1. The second comparator 502 compares the second voltage signal VF2 and the third voltage signal VF to generate a second compared result SC2. Then, the multiplexer 503 determines a voltage value of the specific voltage V_{N} according to the first compared result SC1, the second compared result SC2, the third voltage signal VF, and the fourth voltage signal V1 and adjusts a voltage value of the setting voltage signal V_{SET} outputted from the multiplexer 503 to the output stage OS through a switching way.

For example, the multiplexer 503 can switch the voltage value of the setting voltage signal V_{SET} to a voltage value of the third voltage signal VF or a voltage value of the fourth voltage signal V1, but not limited to this. By doing so, the output stage OS can also adjust a current value of the LED current I_{LED} passing through the light-emitting diode LED accordingly.

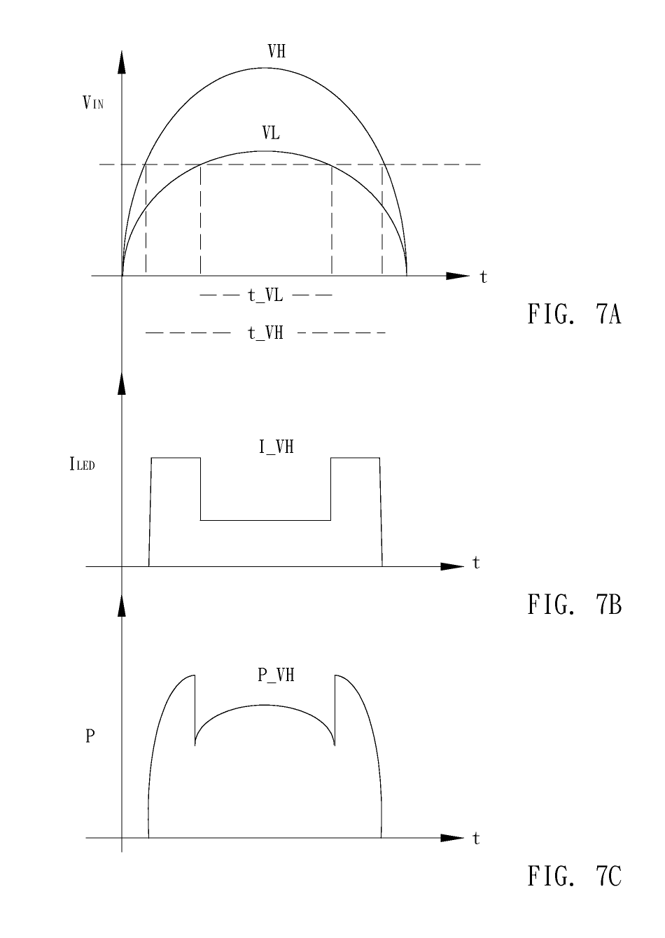

Please refer to FIG. 7A through FIG. 7C. FIG. 7A˜FIG. 7C illustrate wave-form diagrams of the input voltage V_{IN}, the LED current I_{LED}, and the power consumption P of the LED driving apparatus 5 respectively. As shown in FIG. 7B, when the input voltage V_{IN} becomes larger, the current value of the LED current I_{LED} will become smaller. Thus, as shown in FIG. 7C, when the input voltage V_{IN} becomes larger, since the current value of the LED current I_{LED} becomes smaller, the power consumption P of the LED driving apparatus 5 will be decreased instead of being increased. Therefore, the excessive power consumption problem and overheat problem can be effectively avoided.

Another embodiment of the invention is a LED driving apparatus operating method. In this embodiment, the LED driving apparatus operating method is used to operate a LED driving apparatus including an output stage, an input resistor, a plurality of voltage dividing resistors, and a control circuit. The plurality of voltage dividing resistors is coupled between a specific voltage and a ground terminal. The plurality of voltage dividing resistors at least includes a first voltage dividing resistor, a second voltage dividing resistor, and a third voltage dividing resistor coupled in series. A LED current passing through the LED has a duty cycle changed with the specific voltage. The control circuit is coupled to the output stage, another end of the input resistor, between the first voltage dividing resistor and the second voltage dividing resistor, and between the second voltage dividing resistor and the third voltage dividing resistor respectively. The output stage includes at least one LED.

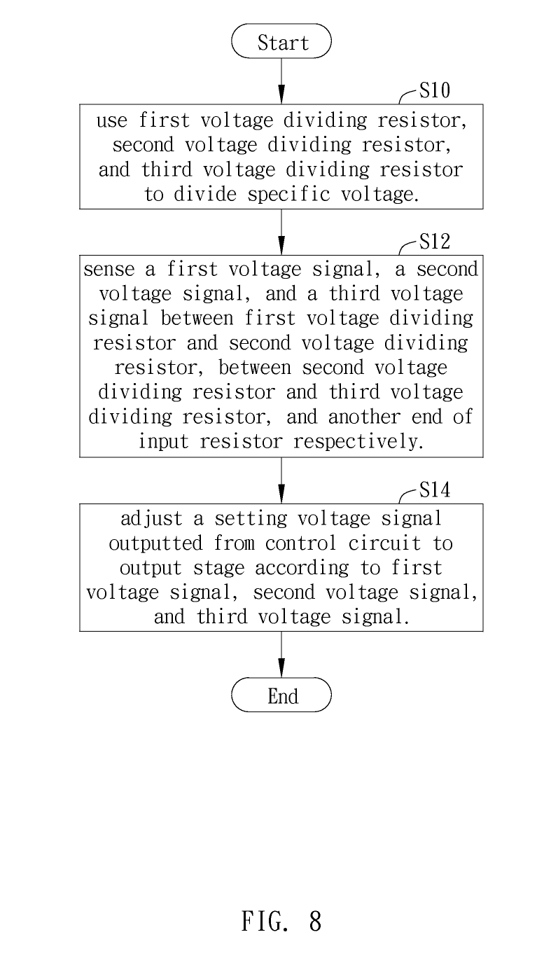

Please refer to FIG. 8. FIG. 8 illustrates a flow chart of the LED driving apparatus operating method in this embodiment. As shown in FIG. 8, at first, the method performs step S10 to use the first voltage dividing resistor, the second voltage dividing resistor, and the third voltage dividing resistor to divide the specific voltage. Then, the method performs step S12 to sense a first voltage signal, a second voltage signal, and a third voltage signal between the first voltage dividing resistor and the second voltage dividing resistor, between the second voltage dividing resistor and the third voltage dividing resistor, and the another end of the input resistor respectively. Afterward, the method performs step S14 to adjust a setting voltage signal outputted from the control circuit to the output stage according to the first voltage signal, the second voltage signal, and the third voltage signal.

In practical applications, the step S14 includes sub-steps of: comparing the first voltage signal with the third voltage signal to generate a first comparison result; comparing the second voltage signal with the third voltage signal to generate a second comparison result; and determining a value of the specific voltage according to the first comparison result, the second comparison result, and the third voltage signal, and adjusting the setting voltage signal outputted to the output stage according to the value of the specific voltage.

In an embodiment, the method can also generate a clock signal and adjust a duty cycle of the setting voltage signal according to the clock signal.

In another embodiment, the LED driving apparatus further includes a regulator, a fourth voltage dividing resistor, and a fifth voltage dividing resistor. The regulator is coupled between the another end of the input resistor and the ground terminal. The fourth voltage dividing resistor is coupled to the another end of the input resistor. The fifth voltage dividing resistor is coupled between the fourth voltage dividing resistor and the ground terminal. The method can sense a fourth voltage signal between the fourth voltage dividing resistor and the fifth voltage dividing resistor and determine the value of the specific voltage according to the first comparison result, the second comparison result, the third voltage signal, and the fourth voltage signal, and adjust a voltage value of the setting voltage signal according to the value of the specific voltage.

Compared to the prior art, the LED driving apparatus and operating method thereof can achieve the effects of: (1) effectively avoiding the excessive power consumption problem and overheat problem when the input voltage is excessive; (2) effectively avoiding the problem of inaccurate LED current at different input voltages, namely the problem of poor input voltage line regulation; (3) making the LED to work at the best current corresponding brightness point.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A LED driving apparatus, comprising:
an output stage, comprising at least one LED;
an input resistor, wherein one end of the input resistor is coupled to an input voltage;
a plurality of voltage dividing resistors, coupled between a specific voltage and a ground terminal, the plurality of voltage dividing resistors at least comprising a first voltage dividing resistor, a second voltage dividing resistor, and a third voltage dividing resistor coupled in series to divide the input voltage, wherein a LED current passing through the LED has a duty cycle changed with the specific voltage; and
a control circuit, coupled to the output stage, another end of the input resistor, between the first voltage dividing resistor and the second voltage dividing resistor, and between the second voltage dividing resistor and the third voltage dividing resistor respectively, the control circuit sensing a first voltage signal, a second voltage signal, and a third voltage signal between the first voltage dividing resistor and the second voltage dividing resistor, between the second voltage dividing resistor and the third voltage dividing resistor, and the another end of the input resistor respectively, and adjusting a setting voltage signal outputted from the control circuit to the output stage according to the first voltage signal, the second voltage signal, and the third voltage signal.

2. The LED driving apparatus of claim 1, wherein the control circuit comprises:
a first comparator, for comparing the first voltage signal with the third voltage signal to generate a first comparison result;
a second comparator, for comparing the second voltage signal with the third voltage signal to generate a second comparison result; and
a multiplexer, coupled the first comparator and the second comparator, for determining a value of the specific voltage according to the first comparison result, the second comparison result, and the third voltage signal, and adjusting the setting voltage signal outputted to the output stage according to the value of the specific voltage.

3. The LED driving apparatus of claim 2, further comprising:
a clock generator, coupled to the control circuit, for generating a clock signal to the multiplexer of the control circuit for the multiplexer to adjust a duty cycle of the setting voltage signal according to the clock signal.

4. The LED driving apparatus of claim 2, further comprising:
a regulator, coupled between the another end of the input resistor and the ground terminal;
a fourth voltage dividing resistor, coupled to the another end of the input resistor; and
a fifth voltage dividing resistor, coupled between the fourth voltage dividing resistor and the ground terminal.

5. The LED driving apparatus of claim 4, wherein the multiplexer is coupled between the fourth voltage dividing resistor and the fifth voltage dividing resistor, the multiplexer senses a fourth voltage signal between the fourth voltage dividing resistor and the fifth voltage dividing resistor and determines the value of the specific voltage according to the first comparison result, the second comparison result, the third voltage signal, and the fourth voltage signal, and adjusts a voltage value of the setting voltage signal according to the value of the specific voltage.

6. The LED driving apparatus of claim 1, wherein the specific voltage is related to the input voltage or a LED voltage of the LED.

7. A method of operating a LED driving apparatus, the LED driving apparatus comprising an output stage, an input resistor, a plurality of voltage dividing resistors, and a control circuit, the plurality of voltage dividing resistors being coupled between a specific voltage and a ground terminal, the plurality of voltage dividing resistors at least comprising a first voltage dividing resistor, a second voltage dividing resistor, and a third voltage dividing resistor coupled in series, a LED current passing through the LED having a duty cycle changed with the specific voltage, the control circuit being coupled to the output stage, another end of the input resistor, between the first voltage dividing resistor and the second voltage dividing resistor, and between the second voltage dividing resistor and the third voltage dividing resistor respectively, the output stage comprising at least one LED, the method comprising steps of:
(a) using the first voltage dividing resistor, the second voltage dividing resistor, and the third voltage dividing resistor to divide the specific voltage;
(b) sensing a first voltage signal, a second voltage signal, and a third voltage signal between the first voltage dividing resistor and the second voltage dividing resistor, between the second voltage dividing resistor and the third voltage dividing resistor, and the another end of the input resistor respectively; and
(c) adjusting a setting voltage signal outputted from the control circuit to the output stage according to the first voltage signal, the second voltage signal, and the third voltage signal.

8. The method of claim 7, wherein the step (c) comprises steps of:
(c1) comparing the first voltage signal with the third voltage signal to generate a first comparison result;
(c2) comparing the second voltage signal with the third voltage signal to generate a second comparison result; and
(c3) determining a value of the input voltage according to the first comparison result, the second comparison result, and the third voltage signal, and adjusting the setting voltage signal outputted to the output stage according to the value of the input voltage.

9. The method of claim 8, further comprising steps of:
generating a clock signal; and
adjust a duty cycle of the setting voltage signal according to the clock signal.

10. The method of claim 8, wherein the LED driving apparatus further comprises a regulator, a fourth voltage dividing resistor, and a fifth voltage dividing resistor, the regulator is coupled between the another end of the input resistor and the ground terminal, the fourth voltage dividing resistor is coupled to the another end of the input resistor, and the fifth voltage dividing resistor is coupled between the fourth voltage dividing resistor and the ground terminal.

11. The method of claim 10, further comprising steps of:
sensing a fourth voltage signal between the fourth voltage dividing resistor and the fifth voltage dividing resistor; and
determining the value of the specific voltage according to the first comparison result, the second comparison result, the third voltage signal, and the fourth voltage signal, and adjusting a voltage value of the setting voltage signal according to the value of the input voltage.

12. The method of claim 7, wherein the specific voltage is related to the input voltage or a LED voltage of the LED.
